(19) United States
(12) Patent Application Publication
(10) Pub. No.: US 2017/0027782 A1
(43) Pub. Date: Feb. 2, 2017

(54) RAPID EVACUATION MAT

(71) Applicant: Brian Jenson, Granite Bay, CA (US)

(72) Inventor: Brian Jenson, Granite Bay, CA (US)

(21) Appl. No.: 14/703,448

(22) Filed: May 4, 2015

(51) Int. Cl. A61G 1/044; A61G 1/048; A61G 1/013

(52) U.S. Cl. CPC A61G 1/044; A61G 1/013; A61G 1/048; A61G 2205/00

(57) ABSTRACT

A system for transporting a person including a top mattress panel having longitudinal sides, a separate detachable bottom panel having longitudinal sides, and a head end edge. The top mattress panel includes a plurality of adjustable securing straps as to adequately fasten a person to the mattress for safe transportation. Pull straps with built-in two stage handles are located along the head end edge of the mattress. Side handles are also located on both sides of the mattress. The head end pull straps are pulled to drag the person, or the side handles are used for carry. In the preferred embodiment the mattress is sufficiently lightweight and flexible to permit the mattress to be compactly rolled and carried on the person, facilitating faster evacuation. The invention is particularly suited to first-responders arriving to a scene where the timeliness of evacuation is essential.

### BACKGROUND OF THE INVENTION

1. Field of the Invention

The present invention relates to a mat for rapid evacuation of persons during emergency and non-emergency situations. More particularly, the invention relates to such a compact and lightweight mat which is easy to use and capable of evacuating or transporting an injured or ill individual.

2. Description of the Related Art

Many methods and systems are known for shifting or moving a patient who cannot move themselves or for evacuation in emergency situations. For example, U.S. Pat. No. 4,793,008, granted on Dec. 27, 1988 to Johansson discloses a patient transfer mat that includes an elongated body portion with a substantially rectangular shape to be placed under the patient. The mat includes grasping openings in each end with slots for securing a strap to secure the individual to the mat. U.S. Pat. No. 4,736,474, granted on Apr. 12, 1988 to Moran, et al., describes an inflatable support member having crossed straps to secure the person being transported. U.S. Pat. No. 5,249,321, granted on Oct. 5, 1993 to Graf discloses an evacuation device for a bed-ridden person comprising of two sheets deployable from head-end or foot-end. U.S. Pat. No. 7,774, 878, granted on Aug. 17, 2010 to Florea, et al., describes an evacuation stretcher that can be deployed from the rescuer's vest. U.S. patent application Ser. No. 11/617,061, published on Dec. 6, 2007 to Walkingshaw describes a sled-type evacuation device to be dragged through the evacuation site.

Most of the devices disclosed in the prior art require several caregivers to transfer the patient onto the evacuation device. This is particularly problematic for first responders who may be limited in assistance. Additionally, many other patents and patent applications employ rigid or semi-rigid supports, belts, or straps to secure the person being transported to the support. One disadvantage of having numerous straps on an evacuation device is that the use in securing each strap delays the process of readying the patient for rescue and evacuation when timing may be critical. Also, because many evacuation devices are not compact, rescuers have to take time to go retrieve the evacuation device from wherever it is stored once they identify an individual is in need of evacuation.

What is needed is a lightweight emergency mat responders can easily carry on their person, is capable of operation by one or multiple caregivers, is durable and withstands use, and provides proper support to firmly hold the patient in place during transit.

The current invention solves this issue by creating an evacuation mat that is lightweight and compact for easy transportation and allows for one caregiver to safely evacuate an individual where necessary. The current invention also has adjustable straps and indicators to show the order in which to secure the victim, eliminating time spent on securing numerous unnecessary straps.

### SUMMARY OF THE INVENTION

The present disclosure attempts to provide a lightweight mobile mat that addresses the problems of the prior art.

This application describes a lightweight mat comprising of a top and bottom rectangular panel. The panels are secured together by Velcro located on the top edges of the bottom panel and the bottom edges of the top panel, which allows the bottom panel to be replaced in the event it gets damaged. The mat comprises adjustable securing straps coupled to an outer surface of the top panel. In the preferred embodiment the securing straps are crossed to form an ‘X’ across the chest of the person secured into the mat. The preferred embodiment also features an adjustable groin strap to further secure the evacuee. The mat features side handles fastened to the bottom of the top panel of the mat as well as pull straps with built-in two stage handles.

It is an object of the present invention to provide a rescue transportation device lightweight enough to be carried on the person of all first responders in all circumstances. This eliminates the lag time created by less mobile transportation devices that cannot easily be carried on your person.

### BRIEF DESCRIPTION OF THE DRAWINGS

FIG. 1 is a top perspective view of the mat according to the first embodiment of the present invention;

FIG. 2 is a top perspective view of the FIG. 1 mat with a figurative person secured in place;

FIG. 3 is a perspective view of the mat in its rolled-up state enclosed in a carrying case and attached to a first responder's uniform vest;

FIG. 4 is a diagram of the FIG. 1 mat in operation on a level surface;

FIG. 5 is a top and bottom perspective view of the FIG. 1 mat with both the secure straps, and carry handles removed to reveal the basic construction of the mat.

### DETAILED DESCRIPTION OF THE DRAWINGS AND INVENTION

A preferred embodiment of the present invention will be described herein below with reference to the accompanying drawings. In the following description, well-known functions or constructions are not described in detail since they may obscure the invention in unnecessary detail.

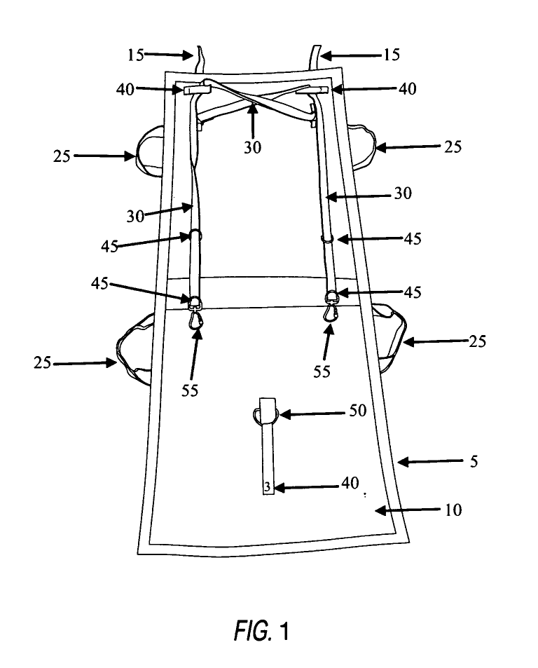

FIG. 1 is a top view of the topside of a mat 5. The mat of the present embodiment is approximately 23×57/inches, but may be larger or smaller depending on the size of the individuals to be carried. The construction of the preferred embodiment is lightweight, providing an easy and convenient way for first responders to quickly evacuate individuals.

The outer skin of the mat (e.g., upper skin panel 10, and lower skin panel 20) is preferably constructed from a lightweight material that resists abrasion and tearing. The upper skin panel 10 and lower skin panel 20 may be secured together using Velcro sewn onto the mat's edges to form a continuous skin. In a preferred embodiment, the skin panels may be constructed from 1680 denier ballistic fabric because it is durable, flexible, and lightweight.

The mat 5 utilizes one continuous securing strap 30 that ensures the person is being transported in a secure manner that reduces the potential for shifting movements. The securing strap 30 is preferably adjustable in length to accommodate both larger and smaller people. In a preferred embodiment, the securing strap 30 may be constructed from a high-strength material such as polypropylene webbing.

The distal ends of the securing straps 15 serve as transport straps. In a preferred embodiment the transport straps at the head end would be used to pull, or tow, the person. Longer transport straps 15 may be secured to the upper metal D rings 45 using metal snap hooks to facilitate ease in evacuation.

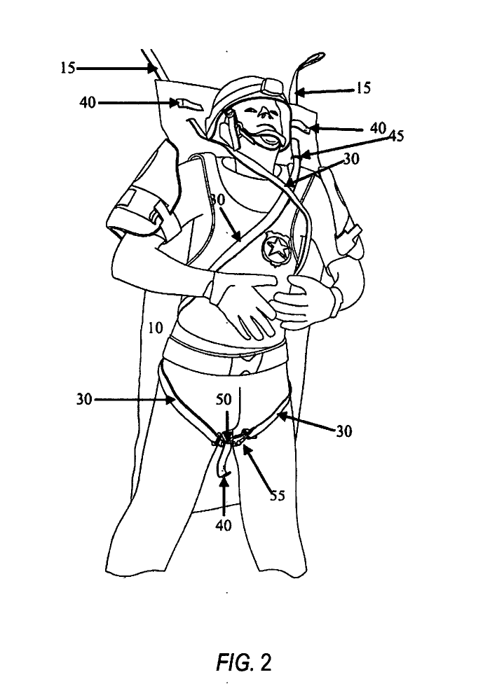

The mat 5 may also have a number of side handles 25 positioned on each side of the mat for use when carrying the person. Although four handles are used in the FIGS. 2 on each side), a person of skill in the art would appreciate that greater or fewer handles may be installed depending on the size of the handles and the size of the mat/person. For added durability, side-handles 25 may be sewn into the various layers of the mat including the bottom denier ballistic layer. In the preferred embodiment, the side-handles 25 may be constructed from a high-strength material such as polypropylene webbing and may be sewn using a durable material such as #69 Bonded Nylon Thread.

FIG. 2 is a top view of the mat 5 with a figurative person secured in place. The securing straps 30 form an ‘X’ across the person's shoulder/upper body region to securely fasten them to the mat 5. The lower securing straps 30 also have metal snap hooks 55 attached to the distal ends that may be attached to metal D ring 50 to secure the groin of the person being transported.

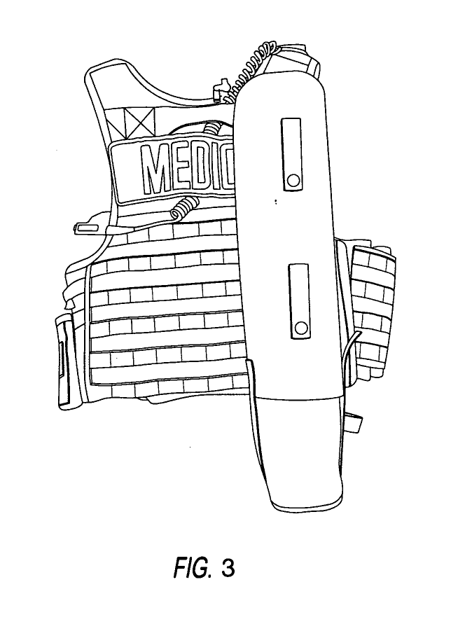

FIG. 3 is a perspective view of the mat in its rolled-up state. In the preferred embodiment the mat 5 can be rolled into a compact form and easily stored in a carrying case. The mat 5 is lightweight and is designed to be attached and carried by emergency personnel in its rolled-up state. Minimal storage and ease of carry is critical to cutting out the typical lag time associated with emergency personnel having to retrieve an evacuation device once its use is deemed necessary.

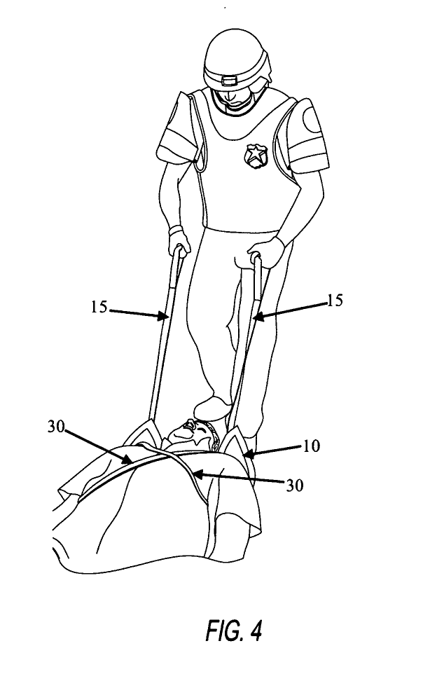

FIG. 4 is a diagram showing the mat in use on a level surface. When two paramedics are available, each is able to pull a strap to ease the overall burden. The patient may be then dragged over various surfaces.

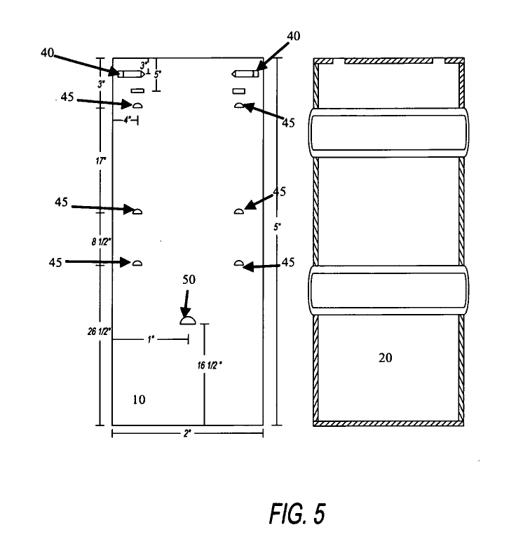

FIG. 5 is a top and bottom perspective view of the mat 5 with the secure straps removed to reveal the basic construction. In the preferred embodiment, the metal D ring 50 is secured approximately 16.5 inches measured from the bottom portion of the top panel of the mat 10. Additionally, the numbered Velcro straps 40 are attached approximately 3 inches from the top portion of the top panel of the mat 10. These measurements may vary in other embodiments of the mat.

The present invention is a rescue mat for rapid evacuation of persons during emergency and non-emergency situations. In the preferred embodiment, the mat serves as a device for a user to place a victim on the mat, securely fasten the victim to the mat, and pull the victim to safety. In other embodiments multiple users may use the mat may to carry a victim by using the handles located on sides of the rescue mat. The present invention improves on the prior art by providing an evacuation system based upon lightweight and inexpensive rescue mats, which are used in conjunction with one or more pull straps or side handles to safely evacuate a victim.

In operation, when responding to an emergency or non-emergency situation the first responder is able to arrive at the scene already carrying the mat on his person in its compact rolled state. Once the responder determines an evacuation is necessary the responder is able to immediately unroll the evacuation mat and begin securing the evacuee into the mat. There is no need to go retrieve an evacuation device from elsewhere.

Once the crossed adjustable securing straps and adjustable groin straps are fastened, the responder can either personally drag the evacuee to safety (regardless of the terrain), or, with the assistance of another responder carry the evacuee to safety using the side handles.

All U.S. and foreign patent documents, all articles, all brochures, and all other published documents discussed above are hereby incorporated by reference into the Detailed Description of the Invention.

What is claimed is:

1. An evacuation mat comprising:
two outer skin panel made of flexible lightweight material;
at least two adjustable securing straps attached to the at least one outer skin panel;
at least two side-handles respectively coupled to opposite sides of the at least one skin panel;
at least one towing strap coupled to the at least one outer skin panel.

2. The mat of claim 1, wherein the at least two securing straps include (i) a crossing chest strap, and (ii) a groin strap.

3. The mat of claim 1, wherein the lower skin panel is attached to the upper skin panel via a securing device.

4. The mat of claim 1, further comprising of numbered straps identifying the proper method of securement.

5. The mat of claim 1, further being easily transportable when carried on the person in its rolled-up state.
